(19) United States
(12) Patent Application Publication
(10) Pub. No.: US 2005/0139323 A1
(43) Pub. Date: Jun. 30, 2005

(54) Linerless label application assembly

(76) Inventors: Gary Vander Syde, Naperville, IL (US); Walter S. Conard, Lake Villa, IL (US); Richard Wojdyla, Wadsworth, IL (US); Jack Olson, Mundelein, IL (US); Fred Hegland, Lake Zurich, IL (US)

Correspondence Address: MCDERMOTT WILL & EMERY LLP, 600 13TH STREET, N.W., WASHINGTON, DC, 20005-3096, US

(21) Appl. No.: 10/884,214

(22) Filed: Jul. 2, 2004

Related U.S. Application Data
(63) Continuation-in-part of application No. 10/745,157, filed on Dec. 23, 2003.
(60) Provisional application No. 60/461,992, filed on Apr. 11, 2003.

(51) Int. Cl. B41M 1/00; B32B 31/00

(52) U.S. Cl. 156/387; 156/510; 156/277

(57) ABSTRACT

A mail piece processing system for applying a printed linerless label to an object, such as a mail piece, includes a printer for printing information on the label material; an unwind assembly for feeding the label material to the printer; a label applicator for cutting a label from the printed linerless label material and applying the label to a mail piece; and, a controller coupled to the label applicator for controlling operation of the label applicator and coupled to the printer for controlling the operation of the printer. The labels contain a repositionable adhesive such that the labels are repositionable labels that can re removed from and re-applied to objects.

### RELATED APPLICATION

This application claims the benefit of U.S. patent application Ser. No. 10/745,157 filed Dec. 23, 2003 entitled “LINERLESS LABEL APPLICATION ASSEMBLY,” which claims the benefit of U.S. Provisional Application No. 60/461,992 filed Apr. 11, 2003 entitled “LINERLESS LABEL APPLICATION ASSEMBLY,” the disclosures of which are entirely incorporated herein by reference.

### TECHNICAL FIELD

The present subject matter relates generally to a linerless label application assembly and a method of applying linerless labels to objects. More specifically, the subject matter relates to mail processing systems having a high speed, linerless label applicator for applying permanent and repositionable adhesive labels to objects such as newspapers, letters, flat mail pieces, parcels and other package mail.

### BACKGROUND

Machines or devices are generally known to cut a label from a continuous roll of label material and to apply the cut label to an object. There are known devices that apply labels from lined label material and other known devices that apply labels utilizing linerless label material. Examples of both types of machines or devices are disclosed in U.S. Pat. Nos. 5,503,702, 5,922,169 and 5,783,032, each of which is expressly incorporated herein by reference in its entirety.

Known devices are designed for use with labels that are carried on a substrate, liner or other backing material. These lined labels have a removable adhesive applied to one side of the label. Lined labels must be “converted” before the labels may be used in the known devices. Converting includes combining the label material with a liner material, die cutting the labels from the blank label material and removing the excess label material from the liner material.

The “converting” steps may be eliminated by using linerless labels, i.e., labels that are not carried on a substrate. Eliminating the conversion steps reduces the cost of the labels by reducing the number of production steps involved in creating the labels, as well as reducing the waste material created by the labels through the elimination of the die cut waste and unnecessary liner material.

Known devices that apply linerless labels to objects are relatively slow and can only apply one size label. Therefore, the applications with which such machines are more limited than linerless label machines. For example, the maximum cycle rate of known devices that apply linerless labels to objects is limited by the vacuum paddle actuation and return time. Successive cycles can not begin until the previous cycle is completed and the paddle returns to the rest position. A need exists, therefore, for a device that can apply labels at high speeds. For example, a need exists for a system that can apply labels that contain either permanent adhesive or repositionable adhesive. Repositionable adhesive has the properties that enable the label to adhere to a document for a period of time, such as 10 days, and still be removed without damaging the document or label. Labels with repositionable adhesive can contain information such as advertisement or coupons, and can be removed from an object and placed onto another object for future use or reference. Additionally, there is a need to apply such labels to other objects, such as parcels, packages and newspapers.

In addition, it is desirable to custom print information on labels for specific individuals or groups that are to receive the labels. Thus when labels are placed on mail pieces, it is also desirable to create a label for a particular mail piece that is addressed to a specific individual. Customization of a label may also include customizing the size of the label that is created for a particular mail piece. The size may need to vary from label to label depending on the amount of information to be printed on a label.

### SUMMARY

The present subject matter provides a linerless label application assembly. The assembly can create linerless labels from a continuous roll of material and apply the label to an object at high speeds. The assembly includes a label applicator with a cutting assembly having a moving blade and a fixed blade. The assembly can be incorporated into a mail processing system to provide high-speed, custom printed and sized labels that can be applied to various objects, such as mail pieces.

The present subject matter also provides a mail piece processing system including a label applicator for cutting a label from linerless label material and a controller. The label applicator includes a cutter assembly having a blade carrier, at least one registration pin on the blade carrier, a fixed blade mounted on the carrier via the registration pin, and a movable blade mounted to the blade carrier. The movable blade moves relative to the fixed blade to cut a label. A silicon based lubricate is automatically applied to the movable blade using a reservoir and wick assembly to prevent adhesive buildup on the blades and rollers. The controller is coupled to the label applicator and controls operation of the movable blade to cut a label.

Additional advantages and novel features of the examples will be set forth in part in the description which follows, and in part will become apparent to those skilled in the art upon examination of the following and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF DRAWINGS

The drawing figures depict one or more implementations in accord with the present concepts, by way of example only, not by way of limitations. In the figures, like reference numerals refer to the same or similar elements. FIGS. 1 thru 8 generally identify the labeler application system according to current teachings. FIGS. 9 thru 17 generally depict alternate examples to enable alternate application techniques and to incorporate label on demand printing.

FIG. 1 is a perspective view of a linerless label application assembly according to the present teachings.

FIG. 2 is a side view of the linerless label application assembly of FIG. 1.

FIG. 3 is a perspective view of an unwind assembly according to the present teachings.

FIG. 4 is a perspective view of a cutter assembly and applicator paddle of the label applicator according to the present teachings.

FIG. 5 is a perspective view of a feed motor assembly with the label material vacuum guide assembly associated with the cutter assembly according to the present teachings.

FIG. 6 is another perspective view of the cutter assembly of FIG. 4, with the pneumatic control values and application paddle assembly removed.

FIG. 7 is another perspective view of the cutter assembly of FIG. 6, with the fixed blade also removed.

FIG. 8 is a top view of a locking mechanism according to the present teachings.

FIG. 9 is a side view of another cutter assembly according to the present teachings with a label direct application assembly added that can be used to apply repositionable labels to newspapers.

FIG. 10 is a front view of FIG. 9 showing the direct application system.

FIG. 11 is a side view of the entire assembly used for direct repositionable label application to documents (newspapers) with integrated print on demand.

FIG. 12 is a perspective view of a cutter assembly with an integrated thermal printer.

FIG. 13 is a perspective view of an alternate implementation of a cutter assembly with and integrated drop-on-demand printer (with print cartridges not shown). An alternate, independently controlled direct application assembly, is shown for applying print on demand address labels.

FIG. 14 is a schematic diagram of a system control for label application and print on demand that is incorporated into any of the alternate label application assemblies.

FIG. 15 is a back perspective view of a label application assembly, which can be used to apply repositionable notes onto a mail piece.

FIG. 16 is a front perspective view of the mail transport and label application assembly, which can be used to apply repositionable notes onto a mail piece.

FIG. 17 is a plan view of a cutter assembly and direct application assembly of the label application assembly shown in FIGS. 15-16.

### DETAILED DESCRIPTION

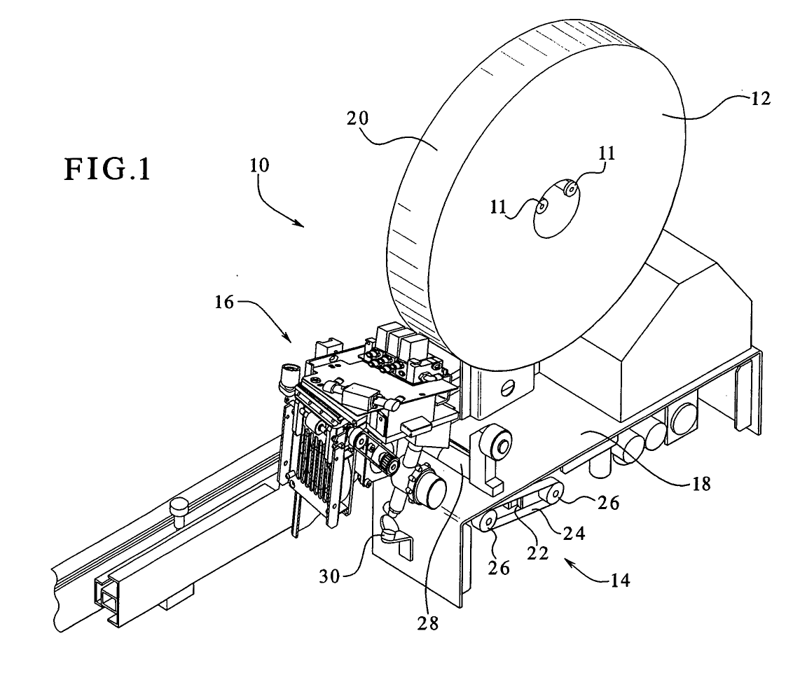

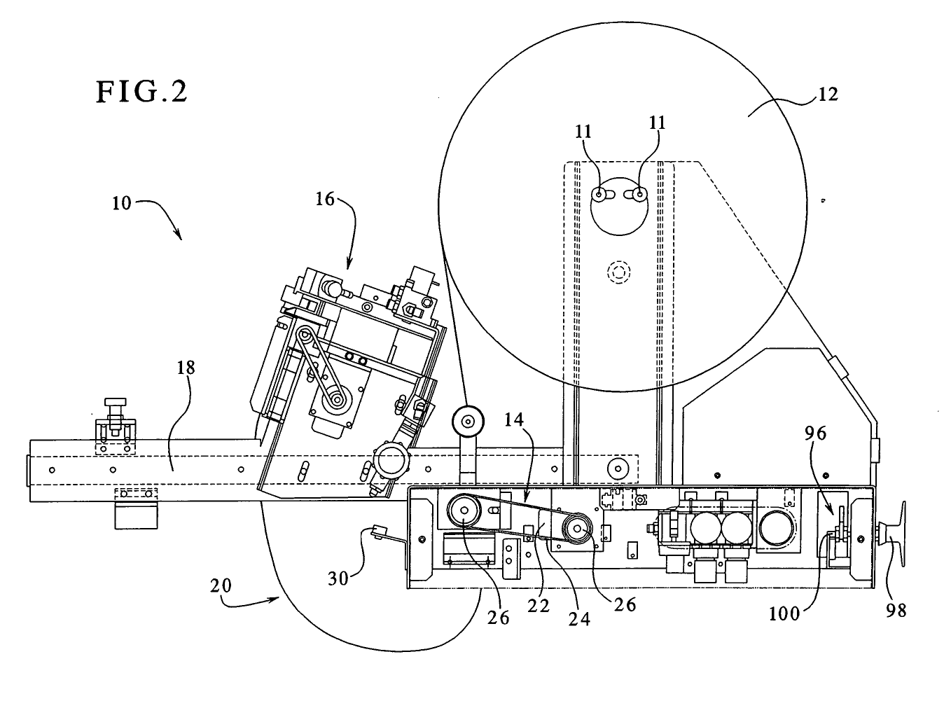

As shown in FIGS. 1 and 2, a label application assembly 10 has two pins 11 for holding a label roll 12. The label application assembly 10 further includes an unwind assembly 14 and a label applicator 16. The label application assembly 10 may be mounted on a frame 18 and may be used in a system for sorting and/or labeling objects, such as, for example, a system for addressing or sorting mail. The label application assembly 10 generally feeds linerless label material 20 from the label roll 12 to the label applicator 16, wherein a on demand variable length of label material 20 is cut and applied to an object, such as, for example, an envelope or newspaper.

The label application assembly 10 may include a standard label roll 12 of label material 20 for forming adhesive labels. The standard label roll 12 may be up to 1,200 meters long and provide enough label material 20 to form approximately 100,000 ½-inch wide labels or about 16,000 3-inch wide labels. Examples of a standard label rolls 12 are manufactured or sold by Moore Label and Form under the trademark AdStix and by 3M Company under the trademark Post-it. Such label rolls 12 contain an acrylic adhesive on the back side of the label material 20. The label material 20 may include a repositionable seven day removable adhesive or permanent adhesive for adhering to various material, such as, for example, polywrap, tyvek and porus materials. The label material 20 may additionally be opaque and ultraviolet light blocking. In addition, thermal sensitive repositionable label material maybe used when thermal printers are utilized. Alternatively, it is contemplated that the label application assembly 10 may incorporate or utilize other non-standard size label rolls 12.

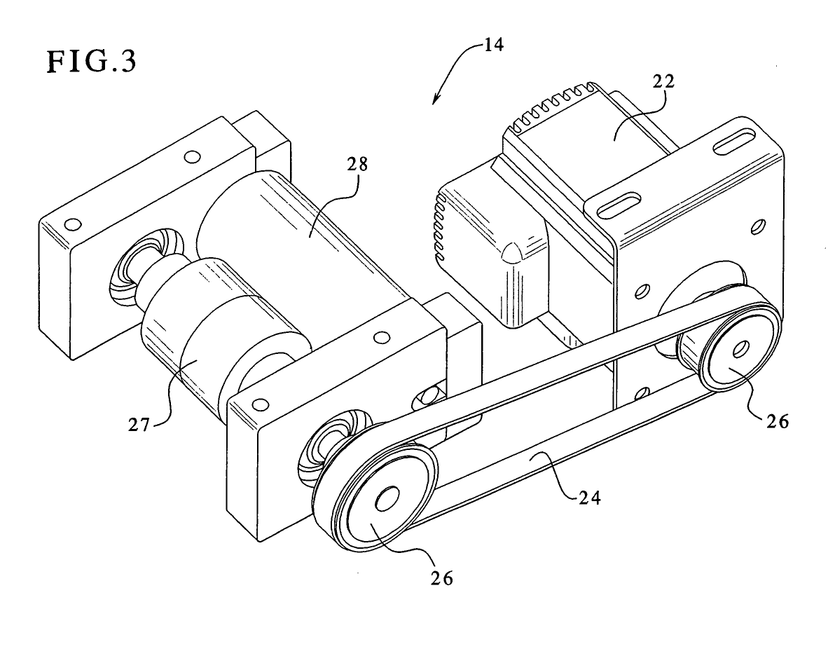

The unwind assembly 14 may be a conventional unwind assembly for unwinding the label material 20 from the label roll 12 such as ones disclosed in U.S. Pat. Nos. 5,503,702, 5,922,169 and 5,783,032, each of which is expressly incorporated herein in its entirety. In the embodiment shown in FIG. 3, an unwind motor 22 is provided to drive the unwind assembly 14 via a drive belt 24 and a first set of drive rolls 27 and 28. The operation of the unwind motor 22 may be controlled by a controller (not shown) to advance the label material 20 from the label roll 12 at a predetermined rate. The unwind assembly 14 unwinds the label material 20 from the label roll 12, feeds the label material 20 over an unwind roller 28, through the bottom of the frame 18 and to the label applicator 16. Preferably, the unwind assembly 14 unwinds a loop of label material 20 in excess of what is required to be fed directly to the label applicator 16. As a result, a loop of excess label material 20 may be gathered between the unwind assembly 14 and the label applicator 16. The loop of label material 20 allows the label applicator 16 to utilize label material 20 from the loop and not directly from the label roll 12, eliminating the problems associated with controlling the inertia of the moving label roll 12. A loop sensor 30 may be coupled to the controller to monitor the size of the loop of label material 20 and activate the motor 22 to unwind additional label material 20 when the loop becomes too small. The loop sensor 30 may be an infrared proximity sensor such as the sensor manufactured or sold by Banner Engineering, Corp. under the name T8 Diffuse-Mode Sensors.

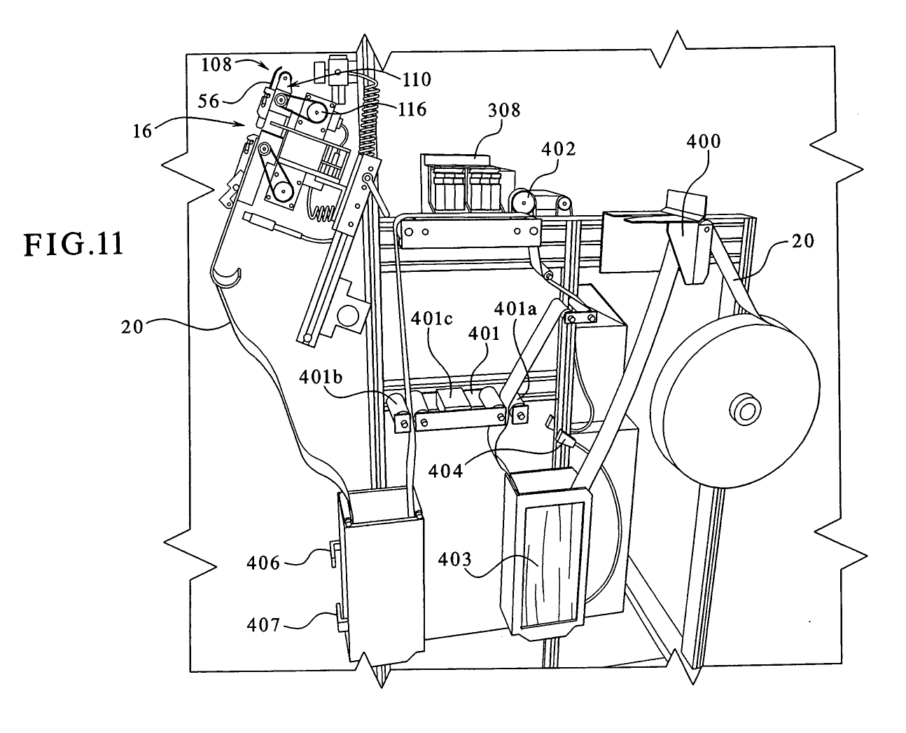

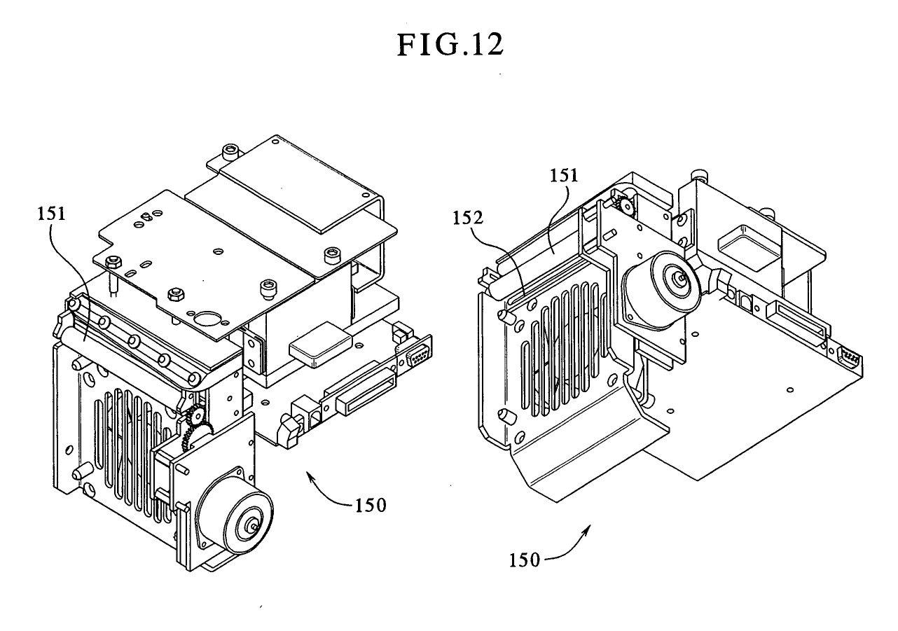

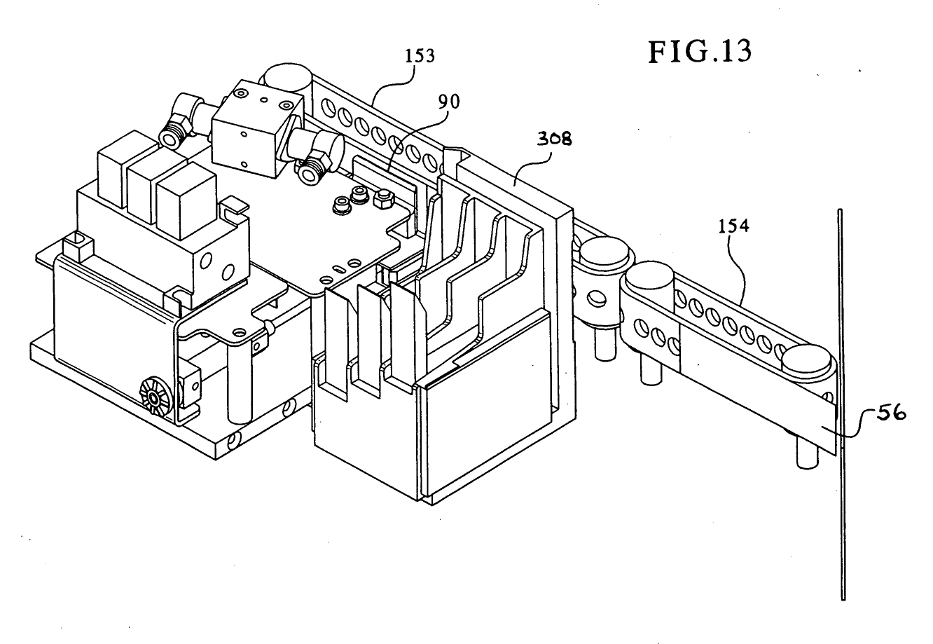

The label application assembly 10 may include a printer for printing on the label material 20. The printer may be integrated with the label application assembly 150 (as shown in FIG. 12), using thermal printer 152 technology with a pressure roller 151 or drop-on-demand-printer 308 technology (as shown in FIGS. 11, 13 and FIG. 15). Additional printing technologies maybe utilized such as thermal transfer 152 (FIG. 12). The integrated drop on-demand printer 308, FIG. 13 uses the label application assembly 16 with a modified label transfer paddle 90 to affix the label to an intermediate belt 153 which may be a vacuum belt system. The intermediate belt 153 will transport the label in front of the drop on-demand printer 308 (print cartridges not shown) where the label will be printed. Following the printing operation, the label is transferred to the application belt 154 which will wipe the label on the item to be labeled. A variable velocity profile is used to drive the application belt 154 at a first velocity to transfer the label from belt 153. The application belt 154 is next driven at a second higher velocity to match its speed with the velocity of the material to be labeled. Flexibility in the use of various printer solutions is possible due to the configuration of the label application assembly 10 where the transfer speed of the label material 20 is much slower than the speed of the item being labeled. This enables the use of thermal transfer and drop-on-demand printers to be operated at material transfer speeds consistent with their design limitations, while applying custom printed labels to material or documents moving at a much higher speed.

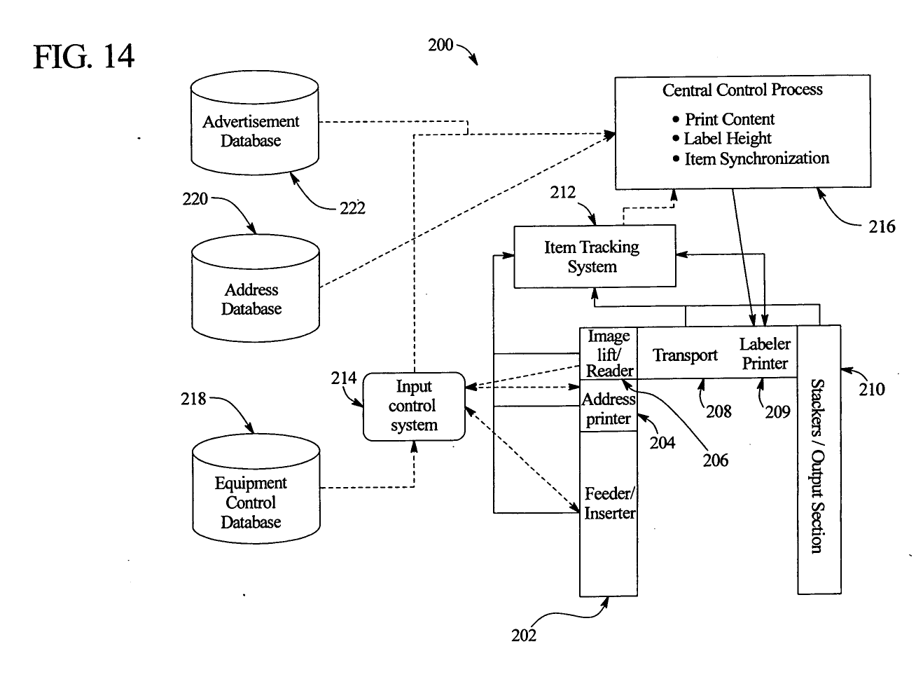

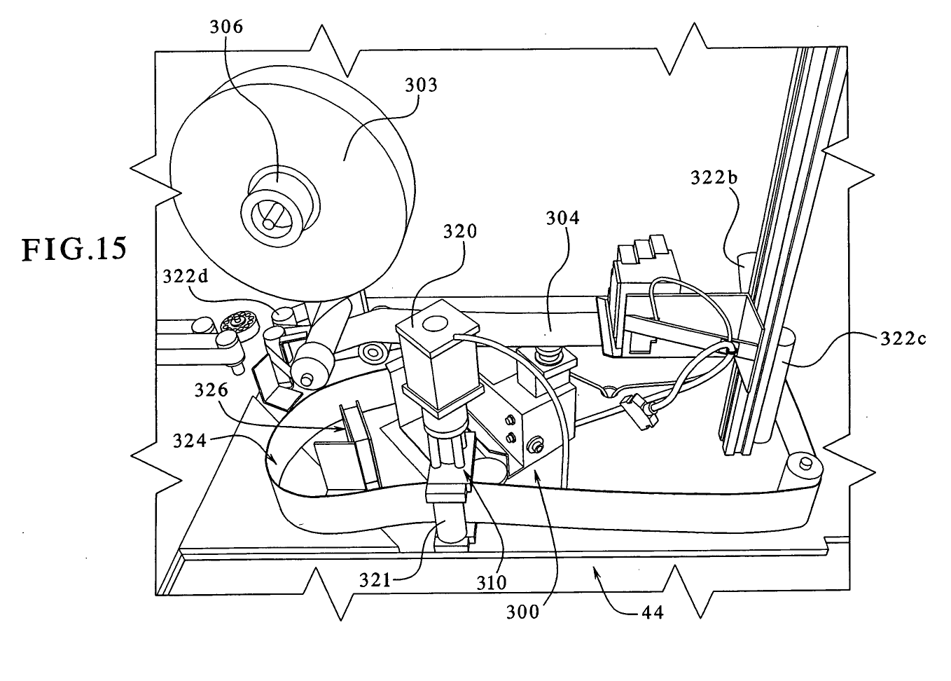

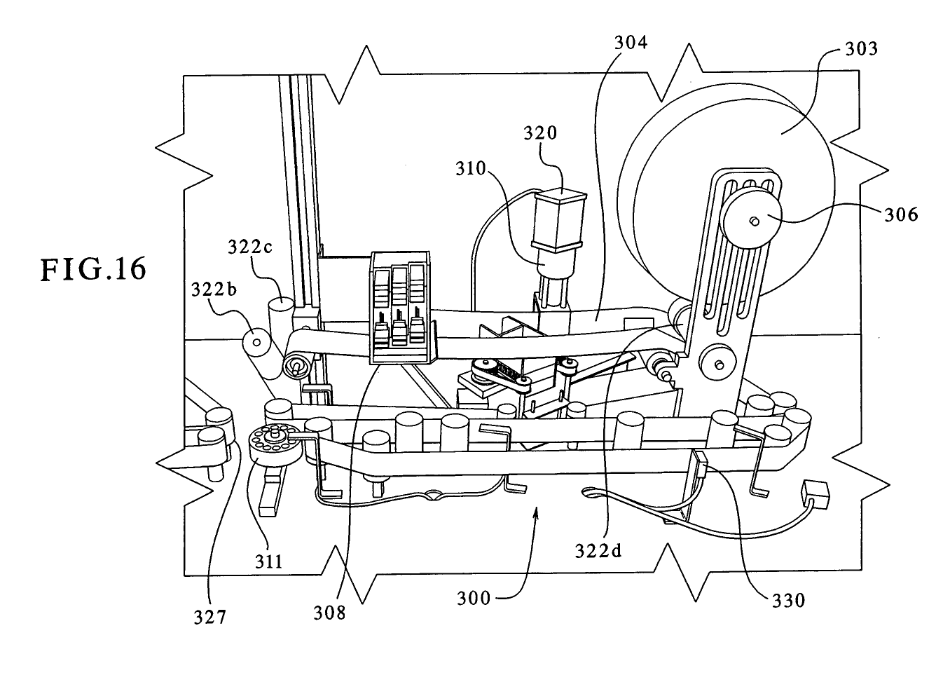

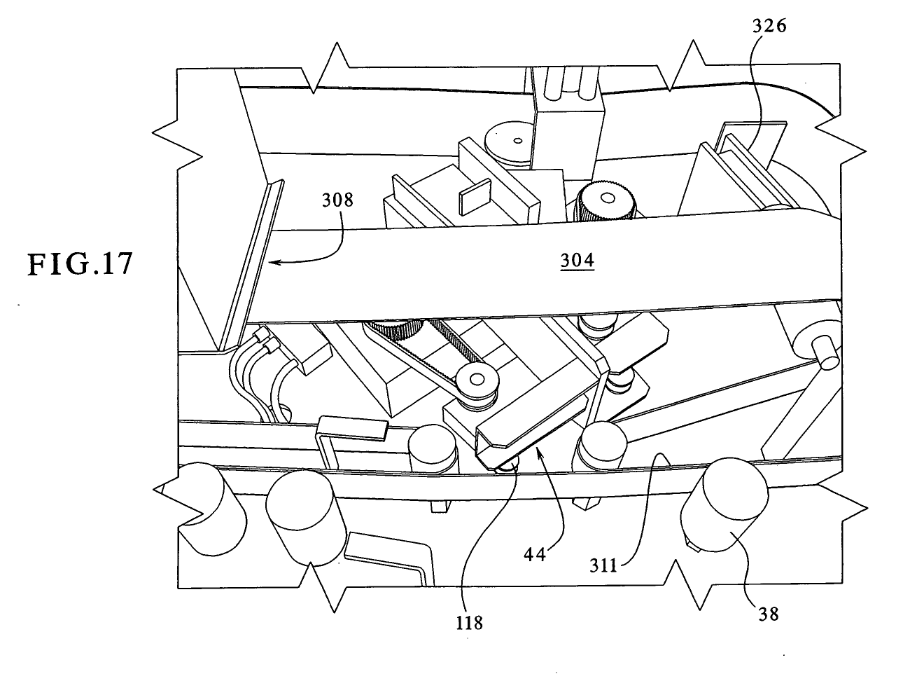

A remotely located printer may also be provided, as shown in FIGS. 15 and 16. This configuration may be used when a significant amount of printing is required. In this configuration, synchronization tick marks can be printed on the label which can be identified by the control system 216 (FIG. 14) so that the control system 216 can ensure that the correct label will be placed on the desired item. The printer may be a high-speed, on-demand printer such as the one manufactured or sold by Hewlett Packard under the trademark HP45 Drop On-Demand printer. The printer may be configured to print onto the label material 304 at speeds fast enough to enable the printer to be located between the unwind assembly 310 and the cutter assembly 44 (FIG. 17) for printing onto the label material 304 as it is fed to the cutter assembly 44. Alternatively, pre-printed labels may be used, limiting or eliminating the use of the printer.

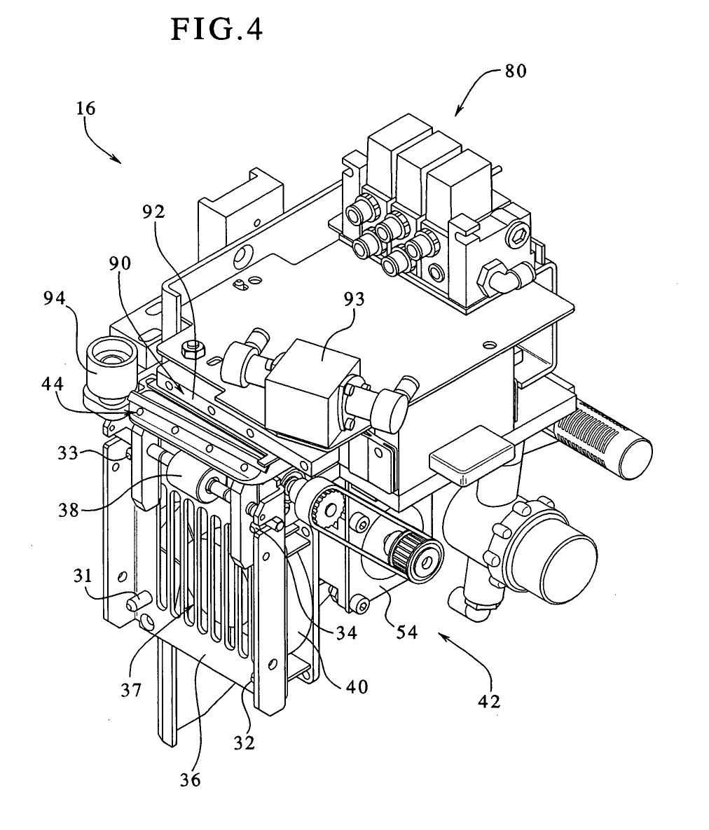

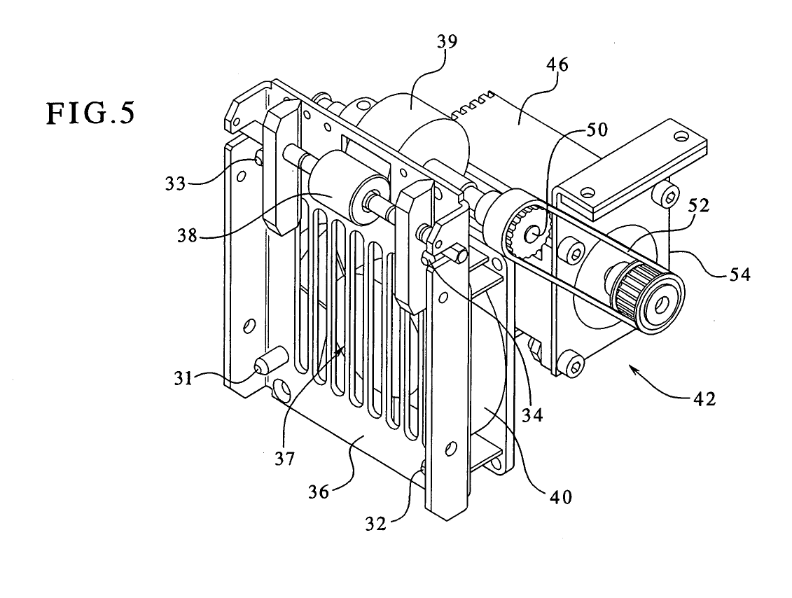

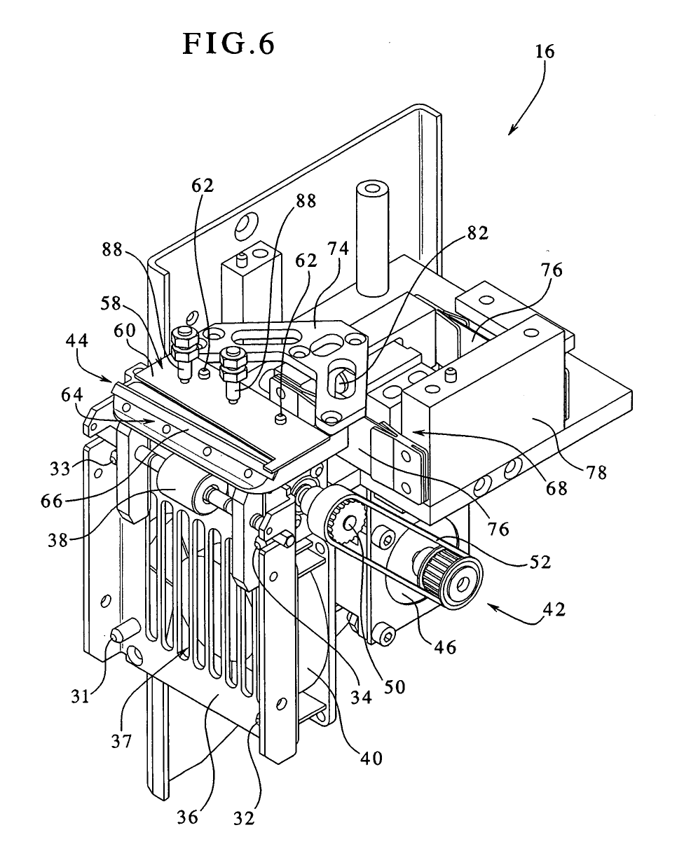

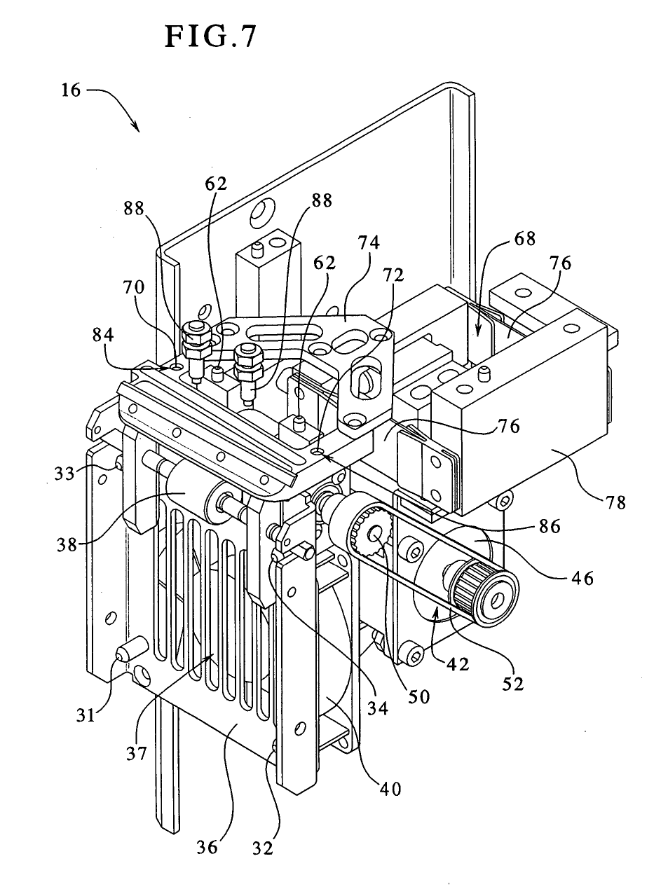

As shown in FIG. 4, the label applicator 16 includes a pneumatic control assembly 80, a feed motor assembly 42 (see FIG. 5), and a cutter assembly 44 (see FIGS. 6-7). The cutter assembly 44 has a guide plate 36 with a set of registration pins 31, 32, 33 and 34 thereon. The cutter assembly 44 also includes a first feed roller 38 and a second feed roller 39. The first feed roller 38 and the second feed roller 39 are collectively referred to herein as the feed rollers 38 and 39. The registration pins 31, 32, 33 and 34 assist in the alignment of the label material 20 along the guide plate 36. As the label material 20 is fed to the label applicator 16 cutter assembly 44 from the label roll 12 by the unwind assembly 14 and feed motor assembly 42, the label material 20 is positioned between the guide pins 31, 32, 33 and 34 along the guide plate 36. The guide plate 36 shown in FIG. 4 is a vented guide plate 36 with vent holes 37 and a fan 40 is provided for creating a light vacuum along the vents 37 of the guide plate 36. The vacuum assists in positioning the label material 20 flat against the guide plate 36 as it is fed towards the feed rollers 38 and 39.

The first feed roller 38 of the feed motor assembly 42 is driven by a feed motor 46 to advance the label material 20 towards the cutter assembly 44. The label material 20 is advanced through the feed rollers 38 and 39 by the driven movement of the first feed roller 38. The feed rollers 38 and 39 may be coated or treated with a material to prevent the label adhesive material 20 from sticking to the feed roller 38. For example, the feed rollers 38 and 39 may be coated using the plasma coating process provided by Magneplate Company under the trademark Plazinadize 1401-04.

FIG. 5 illustrates an embodiment of the feed motor assembly 42 for use with the label applicator 16. The feed motor assembly 42 shown in FIG. 5 includes a feed motor 46, a feed roller axle 50 and a feed motor drive belt 52. The feed motor 46 shown in FIG. 5 is a stepper motor and is controlled by a controller, which is an integral part of the feed motor 46. The controller controls the speed and acceleration of the feed motor 46, as well as the number of steps taken by the feed motor 46. The controller may be a central control processor (as described below with reference to FIG. 14) and may send signals to the assembly 10 such that the number of steps taken by the feed motor varies as needed between each consecutive label that is created to provide variable height labels. Alternatively, the controller may be preprogrammed and may be an integral part of the feed motor 46.

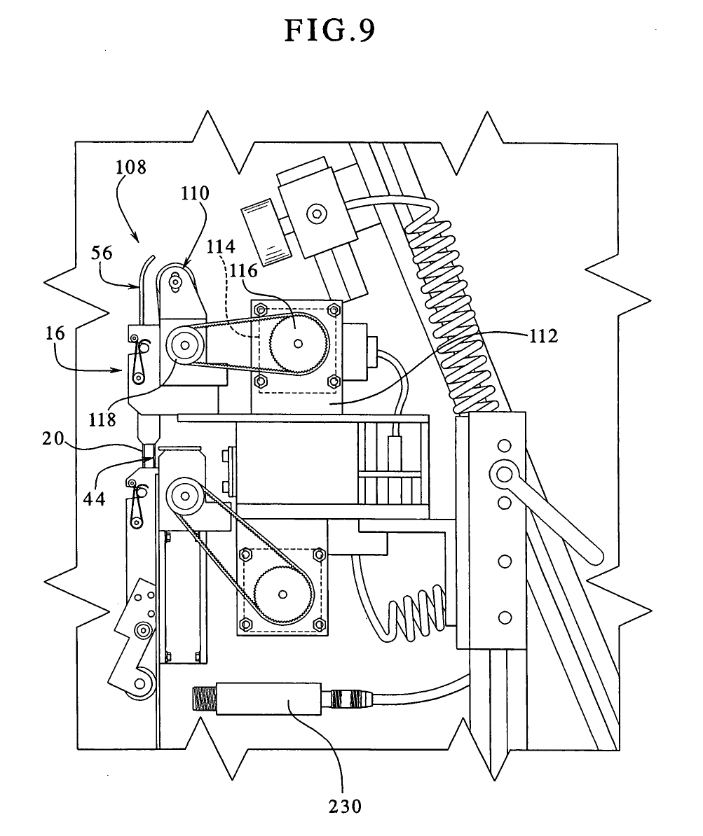

The feed rollers 38 and 39 advance the label material 20 to the cutter assembly 44 wherein a predetermined length of label material 20 is cut to provide a label 56 (see FIG. 9). The cutter assembly 44 will be described with reference to FIGS. 6 and 7. The cutter assembly 44 has a fixed blade assembly 58, including a fixed blade 60 and fixed blade registration pins 62 for attaching the fixed blade to the cutter assembly 44; a moving blade assembly 64, including a moving blade 66 and a spring assembly 68; and a first registration ball 70 and a second registration ball 72 at the interface between the fixed blade assembly 58 and the moving blade assembly 64. The first registration ball 70 and the second registration ball 72 are collectively referred to herein as the registration balls 70 and 72.

As shown in FIG. 6, the moving blade 66 is attached to a moving blade carrier 74. As shown, the moving blade carrier 74 interacts with the spring assembly 68 to control the movement of the moving blade 66 with respect to the fixed blade 60. Alternatively, movement of the moving blade carrier 74 may be controlled by a voice coil which may allow faster cycle times.

The moving blade 66 may be mounted to the moving blade carrier 74 such that the edge of the moving blade 66 is angled upwards towards the fixed blade 60 to facilitate the moving blade 66 passing beneath the fixed blade 60 to cut the label material 20 as described further below. Further, one end of the cutting edge of the moving blade 66 may be positioned slightly closer to the fixed blade 60 than the opposite end of the cutting edge of the moving blade 66 as shown, for example, in FIG. 6. Such skewed alignments of the moving blade 66 may be used to facilitate cutting the label material 20, as described further below. Further, the moving blade 66 may be moved using pneumatic vacuum control means 80 or may be electrically controlled with a device such as a voice coil.

The spring assembly 68 shown in FIG. 6 includes springs 76 mounted to a spring housing 78. The positioning of the springs 76 may be controlled via pneumatic controls 80, which may be mounted to the label applicator 16 as shown in FIG. 4. The springs 76 are coupled to the moving blade carrier 74 and are used to bias the moving blade carrier 74 towards and away from the fixed blade assembly 58. The moving blade carrier 74 may be biased away from the fixed blade assembly 58 to allow label material 20 to be fed between the fixed blade 60 and the moving blade 66. Further, the springs 76 may bias the moving blade carrier 74 towards the fixed blade assembly 58 to cause the fixed blade 60 and the moving blade 66 to cut the label material 20 to form a label 56. As further shown in FIG. 6, a stop 82 is provided to limit the motion of the moving blade carrier 74.

As shown in FIG. 7, the moving blade carrier 74 includes a first socket 84 and a second socket 86 for receiving the registration balls 70 and 72. The first socket 84 and the second socket 86 are collectively referred to herein as the sockets 84 and 86. As shown with reference to FIGS. 6 and 7, the fixed blade 60 mounts to the cutter assembly 44 via the fixed blade registration pins 62. For example, as shown in FIG. 6, a pair of spring plungers 88 may be used to secure the fixed blade 60 to the registration pins and provide a controlled downward force on the fixed blade 60. In the fixed position, the bottom surface of the fixed blade 60 rests upon the registration balls 70 and 72. As a result, the first and second sockets 84 and 86 and the registration balls 70 and 72 may be configured to position the fixed blade 60 at an angle with respect to the moving blade 66. Further, because the registration pins 62 are mounted directly to the cutter assembly 44, the fixed blade 60 may be positioned in a fixed position relative to the label material 20 that is fed through the label applicator 16.

For example, when using identically sized registration balls 70 and 72, the first socket 84 may be configured to position the first registration ball 70 deeper within the moving blade carrier 74 than the second registration ball 72, thereby positioning the first registration ball 70 lower than the second registration ball 72 and enabling the fixed blade 60 to be mounted to the fixed blade assembly 58 at an angle relative to the moving blade 66. Additionally, the fixed blade 60 may be positioned with its cutting edge tilted slightly downward towards the edge of the moving blade 66. Tilting the fixed blade 60 may further facilitate cutting the label material 20 to form a label 56, as described further below. Alternatively, the size and/or configuration of the registration balls 70 and 72 and the sockets 84 and 86 may be varied to otherwise position the fixed blade 60 with respect to the moving blade carrier 74.

The cutter assembly 44 is used to cut the label 56 from the continuous feed of label material 20. When activated to cut the label 56, the moving blade assembly 64 moves towards the fixed blade assembly 58 to create a scissors-like effect along the edge of the fixed blade 60 and the moving blade 66 to cut the label material 20 and form the label 56. The fixed blade 60 and the moving blade 66 may be positioned at skewed angles with respect to each other, as described further above, to facilitate cutting the label 56. The movement of the moving blade assembly 64 may be controlled by one or more controllers (such as ones described below with respect to FIG. 14) that activates the pneumatic controls 80 to operate the spring assembly 68 or voice coil coupled to the moving blade assembly 64.

The controller may be preprogrammed to activate the moving blade assembly 64 based on a timing mechanism, such as, for example, based on the movement of the feed motor assembly 42. Alternatively, a detector (not shown) may be provided for sensing a pre-printed registration-type mark on the label material 20 and sending a signal to the controller to activate the moving blade assembly 64. Further, the label applicator 16 is capable of creating labels 56 of different sizes on demand by varying the length of label material 20 fed through the cutter assembly 44 before activating the moving blade assembly 64. The controller processor selects the length of the label to match the size required to hold the printed material. The data printed on the label may include, without limitation, endorsement data, key line data, addressee, firm name, address, PLANET code, address block POSTNET barcode, mail piece identification mark or code and a customer message. The size of the label may vary and may be determined at least in part by the number of items or lines required for printing, the font size and print format.

After the label 56 is cut from the continuous roll of label material 20, the label 56 is temporarily positioned directly above the fixed blade 60 and the moving blade 66. Referring now to FIG. 4, a paddle assembly 90 is provided to apply the label 56 to an object, such as, for example, an envelope. The paddle assembly 90 shown in FIG. 4 includes a paddle 92 and an actuator 93, which may be pneumatically or electronically activated. The actuator 93 shown in FIG. 4 is a rotary air cylinder. However, the actuator 93 may be an alternative design, such as, for example, a rotary solenoid, a stepper motor, or a servo. The operation of the paddle assembly 90 may be controlled by a controller (as described below with reference to FIG. 14), similar to the controller described above with respect to the moving blade assembly 64. The label applicator 16 shown in FIG. 4 can apply at least ten, three-inch wide labels 56 per second.

In one contemplated embodiment, envelopes are brought to the label applicator 16 along a belt and conveyor system 327 FIG. 15 such as mail sorting machine. The envelopes move along the conveyor system such that each envelope arrives at the label applicator 16 and is positioned adjacent to the label 56 as the cutter assembly 44 severs the label 56 from the label material 20. The label 56 is thereby positioned between the envelope and the paddle assembly 90. The controller then activates the paddle assembly 90 causing the paddle 92 to extend toward the envelope to place the label 56 on the envelope. The relative positions of the label applicator 16 and the conveyor system, as well as the timing of the actuator 93, may be adjusted to control the position the label 56 is applied to the envelope. Similarly, if the assembly 10 has an integrated printer or print head (see FIGS. 12, 16 and 17), print functions can also be controlled and performed prior to the label being severed.

The paddle 92 shown in FIG. 4 is constructed from a light material, such as aluminum. The paddle assembly 90 may also include vacuum chambers (not shown) connected to vacuum holes on the face of the paddle 92 to hold the non-adhesive side of the label 56 as it is applied to the envelope. The size of the paddle 92 may correspond to the size of the label 56 to be applied. For example, it is contemplated that in an embodiment of the paddle assembly 90, the paddle 92 may be approximately one-half of an inch high and five inches long in order to apply labels 56 that are approximately one-half of an inch high by three inches long.

As further shown in FIG. 4, an object roller 94 is provided to secure the label 56 to the envelope, or other object, by applying pressure to the label 56 as the conveyor system removes the envelope, or other object, from above the label applicator 16. The object roller 94 may be a driven roller or an undriven roller. The object roller 94 may be coated or treated with a material to prevent the object from sticking to the object roller 94. For example, the object roller 94 may be coated using the plasma coating process provided by Magneplate Company under the trademark Plazmadize 1401-04. Further, the object roller 94 may be positioned to direct the object away from the paddle assembly 90, assisting the separation of the object and the paddle 94 after the label 56 has been applied.

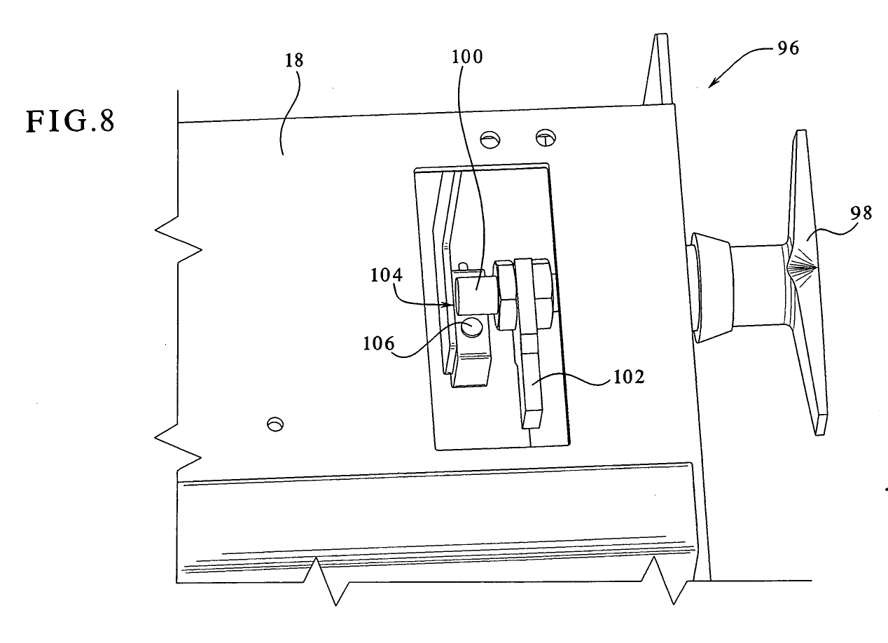

As shown in FIG. 1, the label application assembly 10 is provided on a frame 18. The label application assembly 10 may be a modular assembly and may be disposed on a sliding roller assembly to facilitate easy repositioning and/or removal from the frame 18. Accordingly, the label application assembly 10 may be an integrated, field replaceable label application assembly 10. The sliding roller assembly provides easier access to the label application assembly 10 for servicing and regular maintenance. For example, in a typical installation, the label roll 12 may be changed or renewed daily. A locking assembly 96 may be provided to ensure proper placement of the label application assembly 10 on the frame 18 and to further secure the label application assembly 10 to the frame 18, as shown in FIG. 2. The locking assembly 96 may include a handle 98, a locking axle 100, a hook 102 and a locking sensor 104, as shown in FIG. 8. The locking sensor 104 may include a transmitter 106 and a receiver (not shown), wherein a signal is provided by the transmitter 106 to be received by the receiver. The signal may be, for example, an infrared or other optical signal. The locking sensor 104 may be used to control the operation of the label application assembly 10. For example, when the signal transmitted by the transmitter 106 is not received by the receiver, the operation of the label application assembly 10 may be disabled.

For example, in a contemplated embodiment, when the label application assembly 10 is first positioned on the frame 18, the locking axle 100 may be positioned to prevent the signal from being received by the receiver, thereby disabling the label application assembly 10. However, when the handle 98 is rotated to a locked position, the hook 102 rotates and grasps the frame 18 and the locking axle 100 may be repositioned to allow the signal to be received by the receiver. Consequently, the label application assembly 10 will not operate unless the locking assembly 96 properly engages the frame 18.

In the embodiment depicted in FIG. 8, the locking sensor 104 is a self-contained, retroreflective mode sensor that transmits a signal. The signal is received by the locking sensor 104 only when the locking sensor 104 is properly aligned with a retroreflective target (not shown). The retroreflective target may mounted to the frame 18 in a position that requires the locking assembly 96 to be properly engaged to align the locking sensor 104 and the retroreflective target. Accordingly, the label application assembly 10 must be properly positioned on the frame 18 and the locking assembly 96 must be engaged to expose the retroreflective target to activate the locking sensor 104 and enable the operation of the label application assembly 10.

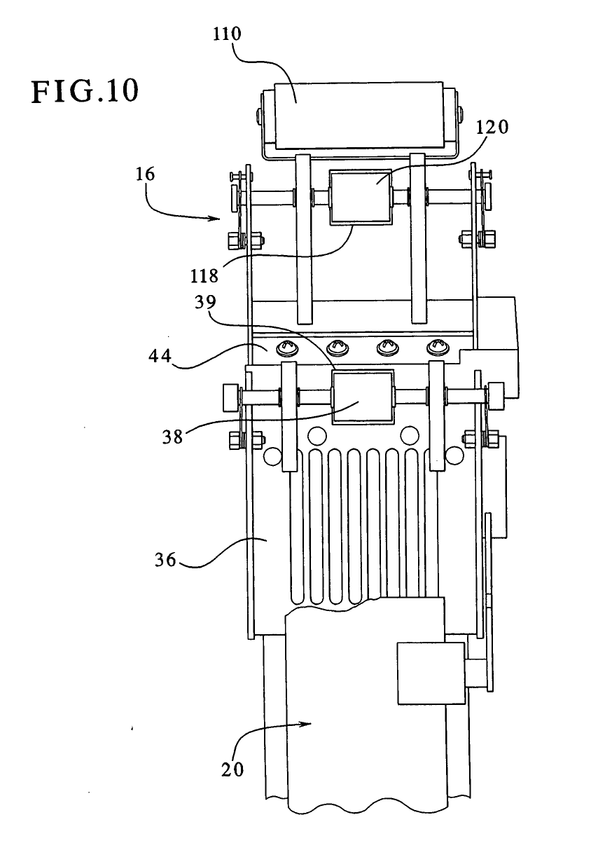

An alternative embodiment of the label applicator 16 is depicted in FIGS. 9, 10 and 11. As shown in FIG. 1, a document 108 such as a newspaper, or other objects, are carried above the label applicator 16 along a conveyor system (not shown). Labels 56 may be formed from label material 20 as described above with respect to FIGS. 1-8; however, in the embodiment shown in FIG. 11, the label applicator 16 does not include the paddle assembly 90 (FIG. 4). Instead a variable speed applicator is used. In this embodiment, pinch rollers 38 and 39 (FIG. 10) are used to advance a variable height of label material to the cutter assembly 44. The height is determined by the control system 216 based on a predetermined height or based on the amount of printing required or based on reading a tick mark printed on the label material 20 using sensor 230. The cut label 56 is advanced into the pinch roller 120 and 118 where if is held prior to application to the newspaper of other item. A control system will advance the label 56 onto the application roller 110 when the presence of document 108 is detected. Motor 114 will run at a speed sufficient to have the label velocity match the document velocity.

A complete label application system for applying labels to newspapers or other items which must be labeled from below is shown in FIG. 11. An alternate approach for repositionable notes is explained with respect to FIGS. 15 through 17. Label material 20 is unrolled from label roll 12 using an unwind assembly 400. The unwind assembly 400 is controlled using a proximity sensor 404. The proximity sensor 404 measures the distance to the loop of label material 20 that is maintained within the vacuum chamber 403 to ensure that a buffer of label material 20 is maintained to guarantee that label material 20 can move smoothly through the drop-on-demand printer or other appropriate printer technology 308. Label material 20 is pulled through the printer 308 with label transport control assembly 401. The label transport control assembly consists of three sections, 401C is the drive motor both 401A and 401B pressure rolls. The 401B rollers are a direct drive from the motor, while the 401A rollers are driven at a slightly slower speed and include a slip clutch. This combination ensures that the label material is held in tension and is pulled past the printer in a uniform manner. Position sensors 406 and 407 that sense the position of the label material loop in the second vacuum chamber 405 control the motor 401C. When sensor 407 is blocked by the label material the motor stops. When sensor 407 detects that no label material 20 is present the motor 401C runs at a slow speed equivalent to the average speed of label material consumption by the labeling assembly 16. If sensor 406, also detects the absence of label material the motor will run at a fast speed to reestablish the label material loop. Operation of the labeler assembly 16 is described below. The printer assembly 308 is designed to print correctly at variable speeds of the label material as caused by the operation of the label transport control assembly 401. An encoder 402 is used to synchronize the printer with the label material velocity, thus preventing distortion in the print quality. The printer may print either a standard or customized message on the label plus a registration mark or tick mark used to control label cutting and placement.

As shown in FIGS. 9 and 10, an application roller assembly 110 is provided to apply the labels 56 to the newspapers 108. The application roller assembly includes an application drive assembly 112 including a motor 114, a drive roller 116, a driven application roller 118 and an undriven application roller 120. The driven application rollers 118 and 39 and the undriven application rollers 120 and 38 may be coated or treated with a material to prevent the object from sticking to the undriven application rollers 118 and 38. For example, the driven application roller 118 and 38 (which contacts the non-adhesive side of the label 56) may be formed from silicone rubber and the undriven application roller 120 and 38 (which contacts the adhesive side of the label 56) may be coated using the plasma coating process provided by Magneplate Company under the trademark Plazmadize 1401-04. The operation of the application drive assembly 112 may be controlled by a controller (not shown) and the controller may be separate from, or part of, the controllers discussed above.

As further shown in FIGS. 9 and 10, the label material 20 is fed through the cutter assembly 44, the label 56 is severed from the label material 20, and the application roller assembly 110 applies the label 56 to the newspapers 108. The label 56 is grasped between the driven application roller 118 and the undriven application roller 120 as it is severed from the continuous label material 20. The driven application roller 118 and the undriven application roller 120 then pull the label 56 away from the label applicator 16 and apply the label 56 to the newspaper 108. By eliminating the time delay associated with the operation of the paddle assembly 90 (FIG. 4), the label applicator 16 shown in FIGS. 9 and 10 may process in excess of 40,000 labels per hour.

Referring now to FIG. 14, a system 200 in which the label application assembly may be incorporated is shown schematically. The system 200 may be a mail sorter system, a mail inserter system, a bindery line, a newspaper press or other special purpose system for transporting items having a transport path through which items can travel. As shown the system includes various mail processing equipment pieces, including a mail piece feeder or inserter 202, an address printer 204, an image lift or reader 206, a transport 208, a label application assembly 209 and a stacker or output section 210. Other processing equipment pieces may also be added to the system 200, e.g., a printer, etc. The system 200 and each of the individual processing equipment pieces 202, 204, 206, 208, 209 and 210, or components on the pieces, may be controlled by various controllers or control systems. For the example, as shown, the configured is for an address printing system which includes the custom printing of personalized messages on repositionable notes that correspond to the mail piece addressee. The system 200 includes an item tracking system 212, an input control system 214 and a central control processor 216.

As shown, the input control system 214 is coupled to the mail piece feeder or inserter equipment 202, the address printer 204 and the image lift or reader 206. The input control system 214 may select data required for addressing or insertion content control from an equipment control database 218. The data is then used to control the address printer 204 and the feeder/inserter 202 or any other data driven function of any other piece of processing equipment in the system 200. For example, the processing equipment may use an image lift reader 206 to read the address and addressee on a mail piece or to read an identification mark such as a barcode on a mail piece. The address and addressee information can be transferred to the input control system 214 and then forwarded to the central control processor 216 for labeler application assembly 209 control, e.g. control of the label application assembly printer, label size and placement on a specific mail piece. If an identification mark is read, the input control system 214 can query the equipment control database 218 to extract address and addressee data from the address database 220 and forward the data to the central control processor 216. In another example, an identification mark may be read and sent to the central control processor 216 which could then query an address database 220 to obtain address information for a mail piece.

As shown, the central control processor 216 is coupled to the label application assembly 209 to control printer and label application functions. As discussed above, the printer can be integrated into the label assembly 209 and/or remotely mounted. The printing functions can be controlled by the central control processor 216 so that the printing is performed on-demand. For example, this printing operation can individually customize one or more labels applied to each mail piece for the addressee/recipient of the mail piece. Label application and printer timing are controlled by the control processor 216 to ensure synchronization between a given mail piece using the item tracking system 212 and creation of a specific label for the given mail piece.

The central control processor 216 controls the operation of both the address printer 204 and the label printer included in 209. A combination of functions can be integrated into the printer control functions which may include utilize address data from the address database 220, advertisement print data from the advertisement database 222 or control commands stored in the Equipment control database 218 to determine the full contents to be printed on the label or mail piece. The content to be printed may include, but is not limited to addressee, address, PlanetCode, POSTNET barcode, USPS endorsement and key line data, a custom message to an addressee and advertisements. Labels can be blank or may contain pre-printed data that will have additional content printed thereon for customization. An advertisement database 222 and the address database 220 may contain data for control of the label assembly 209 or remote printer. Based on the contents to be printed, the central control processor 216 can determine the required label size and the print contents which can be sent to the label application assembly 209 and/or the remote printer. Alternatively, the printer can print a mark on the label material 20, such as a control code, registration mark or tick mark, which can be used by the label applicator 209 to register the label and synchronize the label cutting and application, as described further below. Similarly, registration or other marks may be pre-provided on the label material 20. The label material 20 may be fed from the unwind assembly 14 to the label applicator 209, as described above with reference to FIGS. 4-7 and 9.

As also shown, the item tracking system 212 is coupled to each of the pieces of equipment, 202, 204, 206, 208, 209 and 210. Mail pieces or items can be tracked within the system 200 by the item tracking system 212 so that the exact location of the mail piece or item is precisely known at all times. In this manner, the item tracking system 212 uniquely identifies a mail piece by the addressee and its position in the transport path. The addressee is know by the central control processor 216 by receiving data from the input control system 214, which knows the addressee data used to control the address printer 204, or the document identification data from the equipment control database 218 used for inserter control, or from the Image lift reader 206 which reads the addressee or reads an ID code, such as a barcode, and looks up the addressee in the Equipment control database. Tracking data generated by the item tracking system 212 is used by the central control processor 216 to synchronize the operation of printing onto a label or specific item (mail piece) associated with a specific addressee onto an item. The central control processor 216, in conjunction with the item tracking system 212, will maintain item tracking through starts, stops and jams in the equipment. Resynchronization steps will be communicated to the equipment operation, if required, through existing equipment operator interface. Commands may include removal of already printed labels from the labeler or the removal of items from the equipment for which positive tracking has been lost.

Referring now to FIGS. 15-17, another example of a linerless label system 300 is shown. This embodiment is designed to print customized repositionable notes that will be placed on mail pieces for a specific addressee. The linerless label assembly 300 includes a cutter assembly 44, similar to the cutter assembly 44 described with FIGS. 9, 10 and 11 above. The assembly 300 also may include a holder 306 to hold the roll or web of label material 304, a printer 308 for printing information on the label material 304, an unwind assembly 310 for advancing the label material 304 off of the roll 303. One or more of these items, e.g., the cutter assembly 44 (similar to the assembly in FIG. 9), the printer 308 and unwind assembly 310, may be coupled to and controlled by controllers in a similar manner and with similar functions described above (FIG. 14). In addition, the assembly 300 may be used in a system similar to the system 200 described in FIG. 14. The assembly 300 may be used instead of the label assembly 209, for example. Various other configurations of the system 200 using the assembly 300 could also be used.

The cutter assembly 44 can be used to cut a web of label material 304 containing a repositionable adhesive into one or more repositionable note labels. The material 304 can be a linerless label material, which can be cut by the cutter assembly 44 to create the repositionable note label. As shown, the cutter assembly 44 is positioned adjacent a transport path 311 of a system (such as those systems described with respect to FIG. 14) through which a mail piece can travel. As will be described below in more detail, by positioning the cutter assembly 44 near the transport path 311, a label can be applied to a mail piece as it travels through the transport path 311 without the use of a paddle assembly 90.

Repositionable note labels are generally made from label material 304 that has a repositionable adhesive applied thereto, usually in the form of a strip of the adhesive material applied on one side of the label, so that the label may be placed onto an item and later can be removed and re-applied. For example, if a label contains an advertisement or a coupon, a person may want to save the label for later reference or use. Accordingly, a repositionable note label may be removed from the first object, e.g., a mail piece, and placed onto another object, e.g., refrigerator, for later use. Of course may other possible uses and applications are possible. Two examples of such labels (which were also described above) are manufactured or sold by Moore Label and Form under the trademark AdStix and by 3M Company under the trademark Post-it. A repositionable note label may be affixed directly to an address side of first-class mail and standard mail letter-size mail pieces that meet U.S. Postal Service standards. Of course the labels may be placed on other mail pieces or other objects as well, e.g., they can be placed on newspapers or periodicals.

As shown, the unwind assembly 310 includes an unwind motor 320, which can be a stepper motor and driven feed rollers (not shown) and pressure roller 321. The drive feed roller is driven by the motor 320 such that when the feed rollers are driven, the label material 304 is pulled away from or advanced off of the roll. The unwind motor 320 pulls a web of label material 304 such that a free loop 324 of the material 304 is maintained downstream of the motor 320. A fan 326 may be used to maintain or assist in maintaining the loop 324 configuration. The unwind motor 320 is controlled by a loop sensor mounted next to the fan, similar to the loop sensor 30 described above in FIG. 1. The sensor may also be coupled to a controller to monitor the size of the loop 324 of label material 304 and activate the motor 320 to unwind additional label material 304 when the loop 324 becomes too small. The free loop 324 of material 304 is maintained to allow the cutter assembly feed rollers (described below) to feed the label material 304 to the cutter assembly 44 with constant tension from the roll of material 303 and to prevent the label material 304 from stopping under the printer with each label application. This allows the cutter assembly feed rollers to operate properly and with proper timing and prevents possible print quality loss do to the label material 304 stopping in the middle of a print sequence.

Cylinders or bearings 322b-322d can cause the label material 304 to be rotated through different planes or to move in various desired directions as the material 304 is pulled away from the roll. As the label material is pulled across a cylinder, the cylinder changes the direction that the material travels. Each cylinder 322b-322d is connected to a pressurized air supply of approximately 5 psi. A series of small air holes are located in the cylinder facing the label material which allow air to blow radially outwardly from the surface of the cylinder to create an “air bearing” such that the label material 304 does not actually touch the cylinder, but is still guided around the cylinder and changes the direction of travel. This may be particularly useful on cylinders 322b and 322c which are located downstream of the printer 308, so that after a label has been printed, the printed side of the label material 304 does not touch the cylinders 322b and c. This may prevent ink that has not yet dried on the printed side of the label material 304 from smearing on the label.

As shown, the label material 304 arrives at the printer 308 in a horizontal plane. Note however that the plane in which the label material 304 travels as it arrives at the printer 308 could be varied, e.g., a vertical plane or any other plane provided the printer 308 is positioned accordingly as well.

The printer 308, can also be controlled by a controller to allow printing on the label material 304. The printer 308 can be controlled to operate only when the label web 304 is moving. In other words, the printer 308 may be controlled by or synchronized with the unwind motor 320 such that printing onto the label material 304 occurs only when the label material 304 is moved past the printer's print head. This is to ensure that printing on the label material 304 occurs in the proper position on the material 304 and that the best print quality is provided as well. The print frequency is controlled by an encoder which provides a printer synchronization pulse that changes in frequency dependant on the velocity of the label material directly under the printer. Typically, each encode pulse enables the printer to print a row of drops corresponding to the characters being formed. Without the synchronization the printed message would be improperly stretched or compressed based on the velocity of the label material. Controllers can control the printer 308 such that each label that is printed may be customized for a particular mail piece. Alternately, the printing may be partially customized or not customized at all. Custom printed messages may include, but are not limited to, addressee specific messages, advertisements or coupons.

The label web 304 is also advanced and cut in the cutter assembly 44. As described above with reference to FIG. 9, the cutter assembly 44 has a first set of feed rollers (shown as 38 and 39 in FIG. 9) which advance the label material to the cutter, and a second set of feed rollers (shown as 118 and 120 in FIG. 9). The second set of feed rollers 118 and 120 can be synchronized with the first set of feed rollers utilizing the control system 200.

When a document or mail piece to be labeled is detected in the transport path by an item present sensor 330 both sets of cutter assembly 44 feed rollers advance the label material 304 and a label is cut from the roll of material 303. The first roller advances the web of material 304 to be cut. When the feed roller is not moving, web of material 304 is cut into a label. During this cycle a label that has already been cut is advanced into the transport path and is applied to the document at the transport speed. Subsequently, the newly cut label is advanced into a position such that it can be advanced by the second set of feed rollers into the transport path at the appropriate time.

The advance time in which it takes the feed rollers 118 and 120 to apply a 3-inch label to a mail piece can be about 40 milliseconds. The time that it takes the cutter assembly 44 to cut a label from the web of material 304 is less than 40 milliseconds. Therefore, the total cycle time, the time it takes to cut and apply a label, is about 80 milliseconds which results in a cycle rate of over 40,000 mail pieces per hour, in other words, 3-inch labels can be applied to mail pieces at a rate of over 40,000 per hour. The short cycle time is possible because the cut label moves away from the cutter assembly 44 and the advancing web 304 at the same speed.

Generally, the overall operation of the assembly 300 may include the following steps:
(a) The unwind motor 320 and feed rollers 321 feed label material 304 to the printer 308 and maintains a free loop of material 304.
(b) The printer 308 prints information on the label material 304.
(c) The first set of cutter assembly feed rollers 38 and 39 (FIG. 9A) pulls label material 304 into the cutter assembly 44.
(d) A label is then cut and advanced to a position such that it is ready to be applied to a mail piece as it passes by the cutter assembly 44 in the transport path 311.
(e) The second set of cutter assembly feed rollers 118 and 120 (FIG. 9A) 3 then apply the cut label to the mail piece at the appropriate time.

As discussed above, the assembly 300 may be incorporated and used in a mail processing system, such as one shown in FIG. 14. For example, the system 200 may include a linerless label application assembly 300, or portions thereof, instead of the label assembly 209. In addition, the assembly 300 may be controlled by controllers or other control systems in a manner similar to that described above with respect to the various pieces of equipment, e.g. label application assembly 209.

Many of the control functions discussed above relating to the system 200 are implemented on controllers or computers, which of course may be connected for data communication via the components of a network. The hardware of such computer platforms typically is general purpose in nature, albeit with an appropriate network connection for communication via the intranet, the Internet and/or other data networks.

As known in the data processing and communications arts, each such general-purpose computer typically comprises a central processor, an internal communication bus, various types of memory (RAM, ROM, EEPROM, cache memory, etc.), disk drives or other code and data storage systems, and one or more network interface cards or ports for communication purposes. The system 200 also may be coupled to a display and one or more user input devices (not shown) such as alphanumeric and other keys of a keyboard, a mouse, a trackball, etc. The display and user input element(s) together form a service-related user interface, for interactive control of the operation of the system 200. These user interface elements may be locally coupled to the system 200, for example in a workstation configuration, or the user interface elements may be remote from the computer and communicate therewith via a network. The elements of such a general-purpose computer also may be combined with or built into routing elements or nodes of the network, such as the IWF or the MSC.

The software functionalities involve programming, including executable code as well as associated stored data. The software code is executable by the general-purpose computer that functions as the particular computer for a control system, e.g. the central control processor 216, item tracking system 212, input control system 214 or any other controller. In operation, the executable program code and possibly the associated data are stored within the general-purpose computer platform. At other times, however, the software may be stored at other locations and/or transported for loading into the appropriate general-purpose computer system. Hence, the embodiments involve one or more software products in the form of one or more modules of code carried by at least one machine-readable. Execution of such code by a processor of the computer platform enables the platform to implement the tracking, printing and other functions described above, in essentially the manner performed in the embodiments discussed and illustrated herein.

As used herein, terms such as computer or machine “readable medium” refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s) operating as one of the server platforms. Volatile media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It should be noted that various changes and modifications to the subject matter described herein will be apparent to those skilled in the art. Such changes and modifications may be made without departing from the spirit and scope of the present invention and without diminishing its attendant advantages. It is, therefore, intended that such changes and modifications be covered by the appended claims.

1. A mail piece processing assembly for applying a printed linerless label to an object comprising:
a printer for printing information on the label material;
an unwind assembly for feeding the label material to the printer;
a label applicator for cutting a label from the printed linerless label material and applying the label to the object;
wherein the label applicator includes a cutter assembly having (a) a blade carrier, (b) at least one registration pin on the blade carrier, (c) a fixed blade, the fixed blade being mounted on the carrier via the registration pin, and (d) a movable blade, the movable blade also being mounted to the blade carrier and wherein the movable blade moves relative to the fixed blade; and,
one or more controllers coupled to the label applicator for controlling operation of the label applicator and coupled to the printer for controlling the operation of the printer.

2. The system of claim 1 wherein the label applicator further includes two sets of feed rollers, the first set of feed rollers for feeding label material to the blades to be cut into a label and the second set of feed rollers for moving the cut label away from the cutter assembly.

3. The system of claim 2 wherein the controller sends a signal to the printer representing information to be printed on the label material.

4. The system of claim 3 wherein the information to be printed on the label material is selected from the group consisting of advertising data, addressee data, address data, PlanetCode data, POSTNET barcode data, USPS endorsement data and key line data.

5. The system of claim 4 wherein the label contains repositionable adhesive.

6. The system of claim 1 wherein the unwind assembly includes a motor and at least 2 rollers, wherein the motor drives one of the rollers.

7. The system of claim 1 further including one or more bearings for changing the direction in which the label material is moved through the system.

8. The system of claim 7 wherein at least one of the bearings has pressurized air which can blow air radially outwardly from the surface of the bearing.

9. The system of claim 1 further including a sensor for sensing the presence of label material, the sensor being positioned before the cutter assembly, the sensor also being coupled to a controller for controlling movement of the unwind assembly.

10. The system of claim 9 further including a fan which can generate air movement in the direction of the label material.

11. The system of claim 2 wherein the controller sends a signal to the label applicator to control size of the label created.

12. A method of creating and applying a linerless label to a mail piece traveling through a transport path at a known speed comprising the steps of:
feeding a web of linerless label material to a printer;
printing information on the web of label material;
maintaining a free loop of a web of the printed label material downstream of the printer;
feeding the web of printed label material from the free loop of material to a cutter assembly;
cutting a label from the web of material; the label containing an repositionable adhesive;
applying the cut label to a mail piece at approximately the same speed that the mail piece is traveling in the transport path.
